(19) United States
(12) Patent Application Publication
(10) Pub. No.: US 2009/0168241 A1
(43) Pub. Date: Jul. 2, 2009

(54) Magnetic disk drive

(76) Inventors: Masafumi Mochizuki, Kanagawa-ken (JP); Hideaki Maeda, Kanagawa (JP); Shuji Nishida, Kanagawa (JP); Takaaki Izumida, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/315,810

(22) Filed: Dec. 4, 2008

(30) Foreign Application Priority Data
Dec. 26, 2007 (JP) 2007-333946
Jul. 25, 2008 (JP) 2008-191831

(51) Int. Cl. G11B 5/127

(52) U.S. Cl. 360/125.03; G9B/5.04

(57) ABSTRACT

Embodiments of the present invention help to inhibit record information in a perpendicular magnetic recording disk drive from being attenuated or erased due to leakage of a recording magnetic field into the already-recorded information. According to one embodiment, a magnetic disk includes a soft magnetic underlayer and a magnetic recording layer. A magnetic head includes a main magnetic pole, an auxiliary magnetic pole, a trailing shield which is disposed via a non-magnetic film on a trailing side of the main magnetic pole and in which a reverse side is in contact with the auxiliary magnetic pole, and side shields disposed on both sides of the main magnetic pole. Herein, where a saturation magnetic flux density of the soft magnetic underlayer is Bs_{SUL} and a film thickness thereof is t_{SUL}; a saturation magnetic flux density of the trailing shield and side shields is Bs_{shield} and a film thickness thereof is t_{shield}; and the number of sides of the trailing shield and the side shields, which sides oppose the main magnetic pole, is C1, conditions are set so as to satisfy the following expression:

Bs_{SUL}×t_{SUL}>(1/C1)×Bs_{shield}×t_{shield}.

### CROSS-REFERENCE TO RELATED APPLICATIONS

The instant nonprovisional patent application claims priority to Japanese Patent Application No. 2007-333946 filed Dec. 26, 2007, and to Japanese Patent Application No. 2008-191831 filed Jul. 25, 2008, both of which are incorporated by reference in their entireties herein for all purposes.

### BACKGROUND OF THE INVENTION

An information recording/reading apparatus includes a magnetic recording medium and a magnetic head, in which reading and writing of data on the magnetic recording medium is performed by the magnetic head. In order to increase the recoding capacity of the magnetic recording medium, the areal recording density has to be increased. However, in a conventional longitudinal magnetic recording system there is a problem in that, when a bit length to be recorded is small, a problem of thermal fluctuation in magnetization of the medium takes place, and hence the areal record density cannot be increased.

As a system capable of solving the problem, there is a perpendicular recording system in which a magnetized signal is recorded with a single-magnetic pole head in a direction perpendicular to a double-layer perpendicular recording medium including a soft magnetic underlayer. With this system being used, a recording magnetic field having even higher strength can be applied to the medium. Hence, a material having a large magnetic anisotropy constant can be used for the recording layer of the medium. Further, in the case of the magnetic recording medium using the perpendicular magnetic recording system, there also is an advantage in that magnetic grains are grown in the film thickness direction, whereby the volume can be increased with the particle size diameter remained unchanged, that is, with the bit length remained unchanged. Further, in perpendicular magnetic recording, the direction of the recording magnetization to be formed on the recording medium is perpendicular to the medium surface, so that there is an advantage in that the recording magnetization magnetic field recorded with high density is retained in a stable state. In order to improve the recording density of the magnetic recording device, the perpendicular magnetic recording system has become increasingly used instead of the conventional longitudinal magnetic recording system. For perpendicular magnetic recording, separated recording and reading heads are used as magnetic heads that effect recording and reading. While a magneto-resistance effect head similar to that for conventional longitudinal magnetic recording is used as the read head, a single-magnetic pole head formed from a main magnetic pole and an auxiliary magnetic pole can be used as the recording head.

In the perpendicular magnetic recording system, the recording magnetic field generated from the magnetic head has to be made sharp in order that recording properties, such as resolution and S/N ratio, are improved, and the track recording density and track density is increased thereby. However, since magnetic flux occurring from the main magnetic pole spatially spreads proportionally to the distance from the main magnetic pole, there arises a problem of reducing magnetic field gradient necessary for recording. Further, since the magnetic field reaches adjacent tracks, a problem occurs in that data recorded on the adjacent tracks is likely to be erased. In order to ameliorate these problems, it is effective to reduce the distance between the main magnetic pole and the medium, but a certain size of spacing has to be secured to prevent physical contact between the magnetic pole and the medium.

In order to solve the problems, IEEE Transactions on Magnetics, M. Mallary, Vol. 38, pp. 1719-1724 (2002) (“Non-patent Publication I”) discloses a so-called shielded-type single pole head in which a shield for absorbing magnetic flux occurring from a lateral wall on the trailing side of the main magnetic pole. Thereby, the head magnetic field on the trailing side related to recording can be formed to be sharp. Further, U.S. Pat. No. 4,656,546 (“Patent Publication 1”) or Japanese Patent Publication No. 2005-190518 (“Patent Publication 2”) each disclose a shielded-type single pole head that further includes a shield that absorbs magnetic flux leaking from the main magnetic pole to the side of the adjacent track. With the head being used, the recording magnetic field gradient can be made sharp, and hence the magnetic field to be applied to the adjacent tracks in a recording process can be attenuated.

As described above, the shielded-type magnetic head is characterized in that the magnetic field gradient can be made sharp. However, as the amount of magnetic flux to be absorbed is increased to make the magnetic field gradient sharp, recording magnetic field components in the in-plane direction increases and the reverse polarity magnetic field with respect to the recording magnetic field occurs, for example. The reverse polarity magnetic field can be a cause of deviation and erasure of existing data information. FIG. 4 shows example magnetic field contour lines of the recording magnetic field of a recording magnetic field obtained by three-dimensional magnetic field computation. FIG. 4 shows only the half of the track center, and is magnetic field contour lines in the case of a trailing shield without side shields. A broken-line circular portion corresponds to a portion opposing the main pole and the trailing shield. FIG. 5 shows recording magnetic field distributions along the downtrack direction at the track center. It can be known that the reverse polarity magnetic field with respect to the recording magnetic field occurred in the portion shown by the broken line circle.

The recording magnetic field is indicated as the composite of the perpendicular component and the in-plane component in accordance with the Stoner-Wohlfarth concept, as represented by Expression below.

$$\vert H \vert \cdot {( {sin ( θ )}^{\frac{1}{nSW}} + {cos ( θ )}^{\frac{1}{nSW}} )}^{nSW}$$

Here, |H| is the norm of the perpendicular field component, component in the downtrack direction, and component in the crosstrack direction of the magnetic field. θ is the angle between the magnetic field and perpendicular direction of media surface. nSW is a Stoner-Wohlfarth coefficient, and ordinarily is ⅔. In the present case, taking the properties of the medium into account, the computation was carried out using 1. With an increase in the component in the in-plane direction (the component in the downtrack direction or the component in the crosstrack direction), the effective magnetic field increases. As such, since the strength of the reverse polarity magnetic field increases, it is important to reduce also the in-plane component for erasure inhibition. Further, in the case of a head with side shields, reverse polarity magnetic field occurs also in a position opposing the side shields.

### BRIEF SUMMARY OF THE INVENTION

Embodiments of the present invention inhibit recorded information in a perpendicular magnetic recording disk drive from being attenuated or erased due to leakage of a recording magnetic field into the already-recorded information. According to the embodiment of FIG. 1(a), a magnetic disk 1 includes a soft magnetic underlayer 20 and a magnetic recording layer 19. A magnetic head 14 includes a main magnetic pole 1, an auxiliary magnetic pole 3, a trailing shield 32 which is disposed via a non-magnetic film on a trailing side of the main magnetic pole 1 and in which a reverse side is in contact with the auxiliary magnetic pole, and side shields 33 disposed on both sides of the main magnetic pole 1. Herein, where a saturation magnetic flux density of the soft magnetic underlayer 20 is Bs_{SUL} and a film thickness thereof is t_{SUL}; a saturation magnetic flux density of the trailing shield and side shields is Bs_{shield} and a film thickness thereof is t_{shield}; and the number of sides of the trailing shield 32 and the side shields 33, which sides oppose the main magnetic pole, is C1, conditions are set so as to satisfy the expression below.

Bs_{SUL}×t_{SUL}>(1/C1)×Bs_{shield}×t_{shield}.

### BRIEF DESCRIPTION OF THE DRAWINGS

FIG. 1(a) shows an exemplary cross-sectional schematic view showing a recording head and magnetic disk of an embodiment in a track center, and FIG. 1(b) shows an exemplary view of a peripheral portion of a main magnetic pole of the recording head as viewed from a fly plane.

FIG. 2 is an exemplary plan view showing the overall configuration of an HDD of one embodiment.

FIG. 3(a) shows an exemplary cross-sectional view showing the recording head and magnetic disk of an embodiment in the track center, and FIG. 3(b) shows an exemplary view of a peripheral portion of a main magnetic pole of the recording head as viewed from the fly plane.

FIG. 4 is a field contour lines of recording magnetic fields related to problems that are to be solved by embodiments of the present invention.

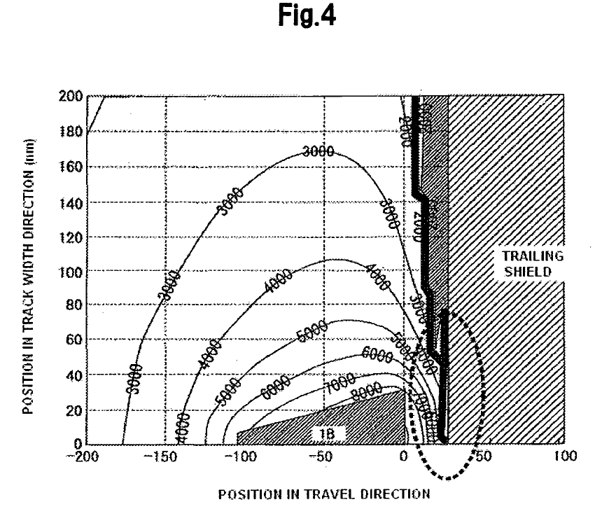

FIG. 5 is a magnetic field profiles of downtrack direction at the track center, which magnetic fields are related to problems that are to be solved by embodiments of the present invention.

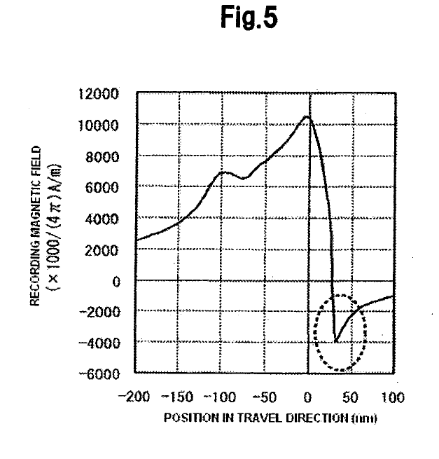

FIG. 6 is an exemplary a magnetic field profiles of downtrack direction at the track center of the recording head of the embodiment which magnetic fields are related to problems that are to be solved by embodiments of the present invention.

FIG. 7 is a magnetic field profile of downtrack direction at the track center of a recording head including only a trailing shield,

FIG. 8 is an exemplary diagram showing the results of three-dimensional magnetic field computation of the recording head related to one embodiment.

FIG. 9 is an exemplary diagram showing the results of three-dimensional magnetic field computation of the recording head related to one embodiment.

FIG. 10 is an exemplary diagram showing the results of three-dimensional magnetic field computation of the recording head related to one embodiment.

FIG. 11(a) shows an exemplary cross sectional view showing a modified example of the magnetic head of the embodiment shown in FIG. 3, and FIG. 1(b) shows an exemplary view thereof as viewed from the ABS.

FIG. 12(a) shows an exemplary cross sectional view showing a modified example of the magnetic head of the embodiment shown in FIG. 3, and FIG. 12(b) shows an exemplary view thereof as viewed from the ABS.

FIG. 13(a) shows an exemplary cross sectional view showing a modified example of the magnetic head of the embodiment shown in FIG. 3, and FIG. 13(b) shows an exemplary view thereof as viewed from the ABS.

FIG. 14 is a schematic diagram showing magnetic filed loop of a magnetic recording medium.

FIG. 15(a) is an exemplary cross-sectional schematic view showing a recording head and magnetic disk of another embodiment in the track center, and FIG. 15(b) is an exemplary view of a peripheral portion of a main magnetic pole of the recording head as viewed from the ABS.

### DETAILED DESCRIPTION OF THE INVENTION

Embodiments of the present invention relate to a magnetic disk drive, and more specifically, to a magnetic disk drive including a perpendicular magnetic recording head including a trailing shield and side shields in a peripheral portion of a perpendicular magnetic recording main magnetic pole, and a magnetic disk including a soft magnetic underlayer.

Embodiments of the present invention address the problem arising in that a recording current is applied to a coil of a recording head, a magnetic field occurring from a main magnetic pole excited thereby leaks into already-recorded record information, and the recorded record information is attenuated or erased.

A typical magnetic disk drive of embodiments of the present invention includes a magnetic disk for perpendicular magnetic recording and a magnetic head for perpendicular magnetic recording. The magnetic disk includes a soft magnetic underlayer, an intermediate layer of a nonmagnetic material, and a magnetic recording layer. The magnetic head includes a main pole, an auxiliary magnetic pole, a trailing shield that is disposed via a non-magnetic film on a trailing side of the main pole and that is in contact with the auxiliary magnetic pole on a reverse side with respect to a side opposing the main pole, and side shields disposed via a non-magnetic film on both sides of the main pole in a crosstrack direction. Herein, where a saturation magnetic flux density of the soft magnetic underlayer is Bs_{SUL} and a film thickness thereof is t_{SUL}; a saturation magnetic flux density of the trailing shield and side shields is Bs_{shield} and a film thickness thereof is t_{shield}; and the number of sides of the trailing shield and the side shields, which sides oppose the main pole, is C1, such that the following expression is satisfied:

Bs_{SUL}×t_{SUL}>(1/C1)×Bs_{shield}×t_{shield}

Where a film thickness of the intermediate layer disposed between the magnetic recording layer and the soft magnetic film underlayer is tEBL, and a magnetic spacing between the magnetic head and the magnetic recording layer is hm,

$$\frac{{Bs}_{SUL} \times {t}_{SUL}}{tEBL} > ( \frac{1}{C 1} ) \times \frac{{Bs}_{shield } \times {t}_{shield}}{hm}$$

is satisfied.

According to embodiments of the present invention, occurrence of a reverse polarity magnetic field with respective to a recording magnetic field is inhibited, and deviation or erasure of already-recorded magnetized information is inhibited, whereby magnetic disk drive having high reliability and high density can be provided.

Particular embodiments of the present invention will be described in detail below with reference to the drawings. Like characters represents like elements numerals in the respective drawings, and duplicated descriptions thereof will be omitted by necessity for the sake of brevity and/or clarity. In the embodiments described below, the present invention is applied to a hard disk drive (HDD) as one example of a magnetic disk drive.

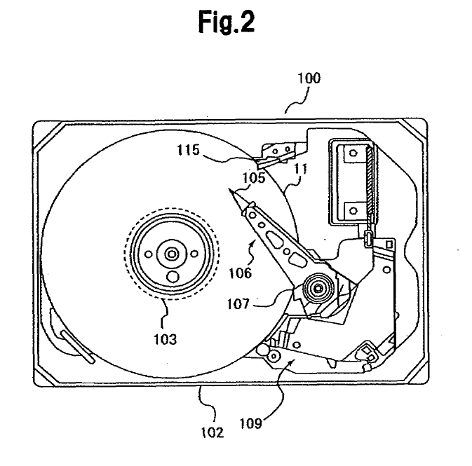

FIG. 2 is a top view of the state of an HDD not having a top cover. The HDD denoted by numeral 100 includes a magnetic disk 11, which is a magnetic recording medium, that records data. The magnetic disk 11 of the present embodiment includes a recording layer and a soft magnetic underlayer.

A head slider 105 includes a magnetic head and a slider, in which the magnetic head performs writing and/or reading of data input or output between itself and an external host (not shown), and the magnetic head is formed on a surface of the slider. The magnetic head includes a recording element and a read element, in which the recording element converts an electric signal to a magnetic field correspondingly to data recorded or written on the magnetic disk 11, and the read element converts to an electric signal a magnetic field emitted from the magnetic disk 11. The configuration of the magnetic head will be described further in detail below.

An actuator 106 holds and moves the head slider 105. The actuator 106 is pivotally held to a rotation shaft 107, and is driven by a voice coil motor 109 (“VCM,” herebelow) that works as a drive mechanism. An assembly of the actuator 106 and the VCM 109 is a moving mechanism of the head slider 105. The magnetic disk 11 is held to a spindle motor 103 (“SPM,” herebelow) fixedly secured to a base 102, and is rotated by SPM 103 at a predetermined angular velocity.

For reading/writing data on (from/onto) the magnetic disk 11, the actuator 106 moves the head slider 105 to a portion over data area of a surface of the magnetic disk 11. Pressure resulting from viscosity of air between an ABS (air bearing surface) of the slider opposing the magnetic disk 11 and the magnetic disk 11 in rotation is balanced with pressure exerted by the actuator 106 towards the magnetic disk 11. Thereby, the head slider 105 is caused to fly at a predetermined gap over the magnetic disk 11.

When, for example, the rotation of the magnetic disk 11 stops, the actuator 106 causes the head slider 105 to move away or retract from the data area to a lamp 115. A control circuit on a control circuit board (not shown) controls operations of the respective components. Embodiments of the present invention can be applied to a CSS (contact start and stop) system in which, in the event of not performing data writing and reading, the head slider 105 retracts to a zone disposed in an inner circumference of the magnetic disk 11. In the above, while, for the sake of brevity, the magnetic disk 11 is of a single disk and a single-side recording type, the HDD 100 can include one or multiple double-sided recording magnetic disks.

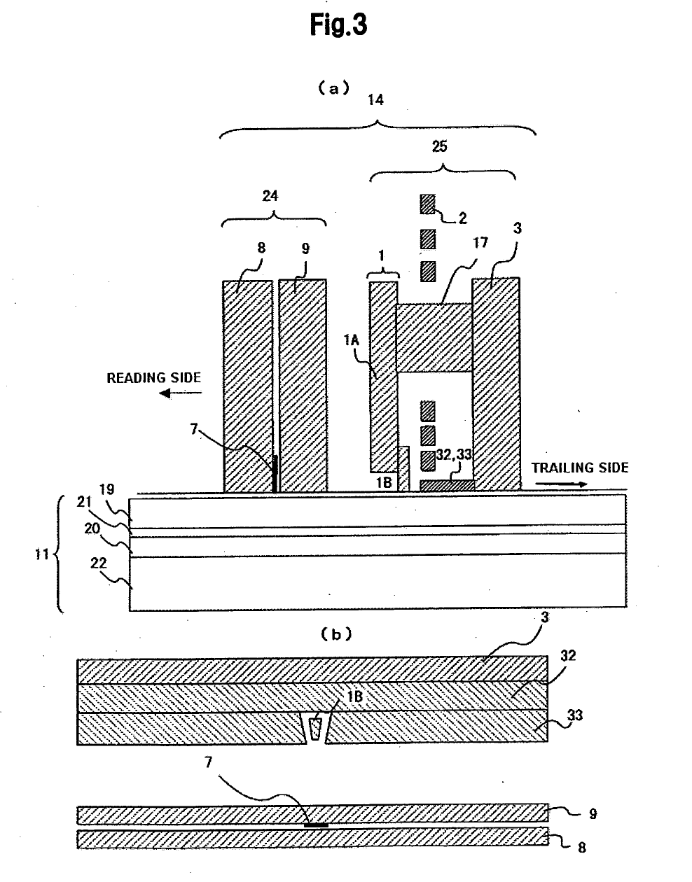

FIG. 3(a) shows a cross sectional configuration of the magnetic head 14, which is mounted to the head slider 105, in a track center; and FIG. 3 (b) shows the configuration of the head slider 105 as viewed from a fly plane (magnetic-disk opposing plane). The magnetic head 14 is a composite recording/reading head including a recording head 25 (single-magnetic pole head) and a read head 24. The recording head 25 includes a main magnetic pole 1 and an auxiliary magnetic pole 3. The read head 24 includes a read element 7 between a pair of magnetic shields (read shields) consisting of a lower shield 8 on a reading side and an upper shield 9 on a trailing side, in which the read element 7 is formed from, for example, a giant magnetoresistive (GMR) effect element and a tunneling magnetoresistive (TMR) effect element.

The main magnetic pole 1 and the auxiliary magnetic pole 3 are magnetically coupled together by a pillar 17 in a position spaced apart from the fly plane. A thin film coil 2 is linked a magnetic circuit configured from the main magnetic pole 1, the auxiliary magnetic pole 3, and the pillar 17. The main magnetic pole 1 is disposed on the reading side of the auxiliary magnetic pole 3. The main magnetic pole 1 is configured from a main magnetic pole yoke section 1A that is coupled by the auxiliary magnetic pole 3 and the pillar 17, and a main magnetic pole tip 1B that is exposed to a head fly plane, and defines the track width.

A magnetic material 32 (trailing shield) is disposed on the trailing side of the main magnetic pole tip 1B via a nonmagnetic material, in which the reverse side thereof contacts with the auxiliary magnetic pole 3. This shield is used to increase a magnetic field gradient of a head magnetic field perpendicular component profile in the downtrack direction. Magnetic materials 33 (side shields) disposed on two sides of the main magnetic pole tip 1B in the crosstrack direction is a shield that is used to reduce magnetic fields along the crosstrack direction, thereby to narrow distributions of recording magnetic fields in the crosstrack direction.

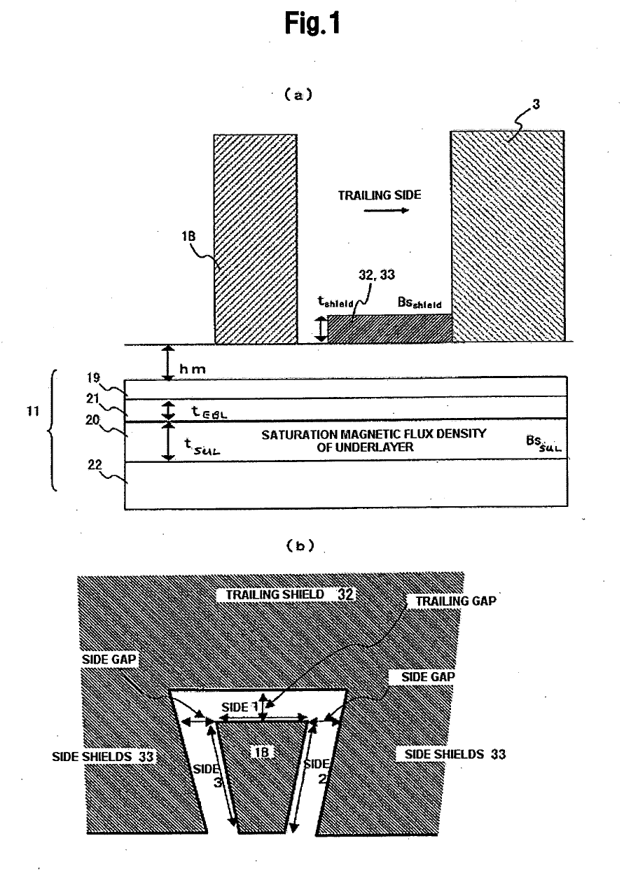

FIG. 1(a) is a cross-sectional schematic view of the magnetic disk 11, a leading edge section of the main magnetic pole tip 1B and the trailing shield 32 of the magnetic head 14 in the track center. FIG. 1(b) schematically shows the shapes of the main magnetic pole tip 1B and neighborhoods thereof as viewed from the ABS (magnetic-disk opposing plane).

In FIG. 1(b), the upper side is the trailing side, and the lower side is the leading side. The recording head 25 includes the side shields 33 on the left and right sides in the radial direction of the main m pole tip 1B and the trailing shield 32 on the trailing side, in the circumferential direction, of the main pole tip 1B. In the example shown in FIG. 1(b), the trailing shield 32 and the side shields 33 are continually, integrally formed. Of course, the trailing shield 32 and the side shields 33 may be in separated structures in which the respective shields are formed independently of one another.

The main magnetic pole tip 1B has a symmetry in the crosstrack direction, in which a width of a leading section is narrower than a width section of a trailing section, that is a trapezoidal shape. When a skew angle occurs between the magnetic head 14 and the magnetic disk 11, the arrangement described above inhibits that data on the adjacent track is erased or attenuated by a magnetic field in the leading section of the main magnetic pole tip 1B. Further, the side shields 33 are formed to conform to bevel angles of the main magnetic pole tip 1B, and the shapes of the side shields 33 conform to the shape of the main magnetic pole tip 1B. However, the shapes of the side shields 33 may not conform to the shape of the main pole tip 1B.

The magnetic disk 11 includes a soft magnetic underlayer 20 and a magnetic recording layer 19 on a non-magnetic substrate 22, and further includes an intermediate layer 21 between the soft magnetic underlayer 20 and the magnetic recording layer 19

Magnetic flux emanated from the main magnetic pole 1 of the recording head 25 forms a magnetic circuit that passes through the magnetic recording layer 19 and the soft magnetic underlayer 20 of the magnetic disk 11 and enters the auxiliary magnetic pole 3, whereby a magnetized pattern is recorded onto the magnetic recording layer 19.

Next, the following describes conditions for inhibiting occurrence of a reverse polarity magnetic field to a recording magnetic field in order to inhibit deterioration or erasure of already recorded magnetized information in the relationship between the magnetic head 14 and the magnetic disk 11 as described above. With reference to FIG. 1(a), a saturation magnetic flux density of the soft magnetic underlayer 20 is represented by Bs_{SUL}, and a film thickness thereof is represented by t_{SUL}; the saturation magnetic flux density of the respective trailing shield 32 and the side shields 33 is represented by Bs_{shield} and the film thickness thereof is represented by t_{shield}; and the number of the sides of a shield opposing the main magnetic pole tip 1B is represented by C1. In this case, in embodiments of the present invention, the relationship represented by [Expression 1] below is satisfied.

Bs_{SUL}×t_{SUL}>(1/C1)×Bs_{shield}×t_{shield} [Expression 1]

In [Expression 1], the left side is indicative of the degree of the ease of flowing of magnetic flux from the main magnetic pole 1 to the soft magnetic underlayer 20, and the right side is indicative of the degree of the ease of flowing of magnetic flux to the trailing shield 32 and the side shields 33. As the saturation magnetic flux density is greater or as the layer thickness is larger, the magnetic flux becomes more likely to flow. Further, in the case of only the trailing shield 32, C1 is 1; and in the case the trailing shield 32 and the side shields 33 are disposed in the left and right, C1 is 3. In the case of the present embodiment shown in FIG. 1 is, therefore, 3. This means that as the number of sides opposing the main pole tip 1B is greater, the magnetic flux becomes more likely to flow the shields. Consequently, in the event that [Expression 1] shown above is satisfied, flowing of the magnetic flux into the trailing shield 32 and the side shields 33 is inhibited, but the magnetic flux flowing into the soft magnetic underlayer 20 of the magnetic disk 11 increases. Thereby, the strength of the reverse polarity magnetic field with respect to the recording magnetic field that is applied to the track on which the magnetized information is already recorded can be reduced. Consequently, the magnetic recording device having high reliability and high density can be provided.

Materials for the soft magnetic underlayer 20, which comprises the magnetic disk 11, include materials having a high saturation magnetic flux density include, for example, the FeCo group, FeCoB, FeCoV, FeSi, and FeSiB—C. Materials therefor each having a saturation magnetic flux density lower than the above include, for example, CoTaZr, CoZrNb, FeNi, FeCr, NiFeO, AlFeSi, and NiTaZr. Materials for the magnetic recording layer 19 include, for example, a CoCrPt—SiO2 granular film, an ordered FePt alloy, an artificial grid film of Co/Pd and Co/Pt, and an amorphous film of TbFeCo. Materials for the intermediate layer 21 include, for example, Ru.

In the configuration described above, the film thicknesses or saturation magnetic flux densities of the side shields 33 and the trailing shield 32 are different from one another, [Expression 1] shown above is expressed as follows.

Bs_{SUL}×t_{SUL}>Bs_{trailing}_{_{—}}_{shield}×t_{trailing}_{_{—}}_{shield}+(½)×Bs_{side}_{_{—}}_{shield}×t_{side}_{_{—}}_{shield}

In the above, the saturation magnetic flux density of the side shields 33 is represented by Bs_{side}_{_{—}}_{shield}, shield, and the film thickness is represented by t_{side}_{_{—}}_{shield}.

Further, in the case the film thicknesses or saturation magnetic flux densities of the respective left and right side shields 33 are different from one another, [Expression 1] shown above is expressed as follows.

Bs_{SUL}×t_{SUL}>Bs_{trailing}_{_{—}}_{shield}×Bs_{trailing}_{_{—}}_{shield}+Bs_{side}_{_{—}}_{shield}_{_{—}}₁×Bs_{side}_{_{—}}_{shield}_{_{—}}₁+Bs_{side}_{_{—}}_{shield}_{_{—}}₂×t_{side}_{_{—}}_{shield}_{_{—}}₂

In the above, the saturation magnetic flux densities of the respective left and right side shields 33 are represented by Bs_{side}_{_{—}}_{shield}_{_{—}}₁ and Bs_{side}_{_{—}}_{shield}_{_{—}}₂, and the film thicknesses thereof are represented by t_{side}_{_{—}}_{shield}_{_{—}}₁ and t_{side}_{_{—}}_{shield}_{_{—}}₂.

Further, the relationship expressed by [Expression 2] below is controlled to be satisfied, where the rate that the shields oppose the outer circumference of the main pole tip 1B is represented by C2 from a viewpoint similar to the above.

Bs_{SUL}×t_{SUL}>(C2)=Bs_{shield}×t_{shield} [Expression 2]

This is because as the length that opposite to the main magnetic pole tip 1B is larger, the magnetic flux becomes more likely to flow. Thereby, the strength of the reverse polarity magnetic field with respect to the recording magnetic field that is applied to the track on which the magnetized information is already recorded can be reduced.

Further, the configuration can be formed to satisfy [Expression 3] shown below, in which a magnetic distance to the magnetic recording layer 19 from the magnetic head 14 is represented by hm, and the film thickness of the intermediate layer 21 formed of the non-magnetic film is represented by tEBL.

$$\frac{{Bs}_{SUL} \times {t}_{SUL}}{tEBL} > ( \frac{1}{C } ) \frac{{Bs}_{shield } \times {t}_{shield}}{hm} \qquad [ Expression 3 ]$$

In this case, C is C1 described above or 1/C2. As the film thickness of the intermediate layer 21 is smaller, the magnetic flux becomes more likely to flow to the soft magnetic underlayer 20. Concurrently, as the magnetic distance is smaller, the magnetic flux becomes more likely to return to the shields through the soft magnetic underlayer 20. Thereby, the strength of the reverse polarity magnetic field with respect to the recording magnetic field that is applied to the track on which the magnetized information is already recorded can be reduced, and deterioration and erasure of the recorded magnetized information can be even more securely inhibited.

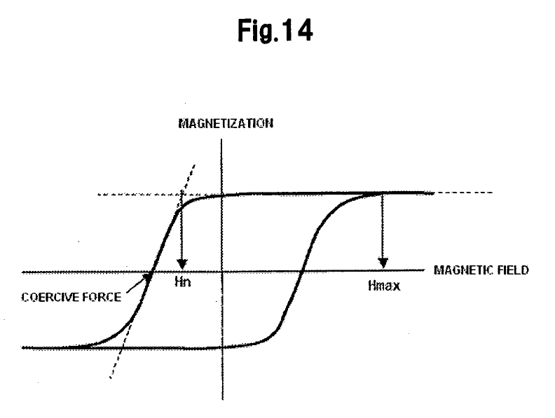

Further, in view of the properties of the magnetic disk 11, it can even be considered that the reverse polarity magnetic field can be tolerated to a value less in absolute value than a value Hn at which a tangent line drawn from a negative coercive force of the magnetic disk 11 reaches the level of saturation magnetization level (see FIG. 14). The configuration can be formed to satisfy [Expression 4] shown below, where the rate (Hn/Hmax) between Hn and a recording magnetic field strength Hmax is represented by C3.

$${Bs}_{SUL} \times {t}_{SUL} > ( 1 + C 3 ) \times ( \frac{1}{C} ) \times {Bs}_{shield } \times {t}_{shield} \qquad [ Expression 4 ]$$

In the above, C is C1 described above or 1/C2.

In the relationship between the magnetic head and the magnetic disk of one embodiment, the recording magnetic field generated from the main pole 1 was computed through three-dimensional magnetic field computation. In this case, the thickness of the soft magnetic underlayer 20 was set to be 20, 40, and 60 nm. The thicknesses of the trailing shield 32 and the side shields 33 were set to be 50 nm. The distance between the main pole tip 1B and the trailing shield 32 were set to be 27 nm. The distance between the main pole tip 1B and the side shields 33 were set to be 50 nm.

Other calculation conditions are as described hereinbelow. A width Pw of the main magnetic pole tip 1B was set to be 50 nm. The leading edge section of the main pole tip 1B was set to have a bevel angle of 8 degrees, and was set to be a trapezoidal shape in which the leading section has a narrow width. The film thickness was set to be 106 nm. Contemplating that CoNiFe is used as a material of the main pole tip 1B, the saturation magnetic flux density was set to be 2.4 T, and the relative magnetic permeability was set to be 500. For the main magnetic pole yoke section 1A of the main magnetic pole 1, a material of 80 at % Ni-20 at % Fe with a saturation magnetic flux density of 1.0 T was contemplated for use. For the auxiliary magnetic pole 3, a material with a saturation magnetic flux density of 1.0 T was contemplated for use. In this case, as a size, the width in the crosstrack direction was set to be 30 μm, the length in the element height direction was set to be 16 μm, and the film thickness was set to be 2 μm.

For the upper shield 9 and the lower shield 8, a material of 80 at % Ni-20 at % Fe with a saturation magnetic flux density of 1.0 T was contemplated for use. In this case, as a size, the width in the track width direction was set to be 32 μm, and the length in the element height direction was set to be 1.5 μm. For the magnetic material of the trailing shield 32 and the side shields 33, contemplating a material of 45 at % Ni-55 at % Fe for use, the saturation magnetic flux density was set to be 1.7 T, and the relative magnetic permeability was set to be 1000. The number of turns of the coil 2 was assumed to be five, and the recording current value was assumed to be 35 mA.

As a material of the soft magnetic underlayer 20 of the magnetic disk 11, a material with a saturation magnetic flux density of 1.35 T was contemplated for use. For the magnetic recording layer 19, the film thickness was considered only to be 16 nm. The thickness of the intermediate layer 21 was assumed to be 15.5 nm, and distance from the magnetic head 14 to the surface of the magnetic recording layer 19 was assumed to be 8.5 nm. Hence, the distance from the magnetic head 14 to the soft magnetic underlayer 20 was set to be 40 nm. The recording magnetic field was computed in a position contemplated to correspond to a magnetic recording layer center position at 16.5 nm from the fly plane of the magnetic head.

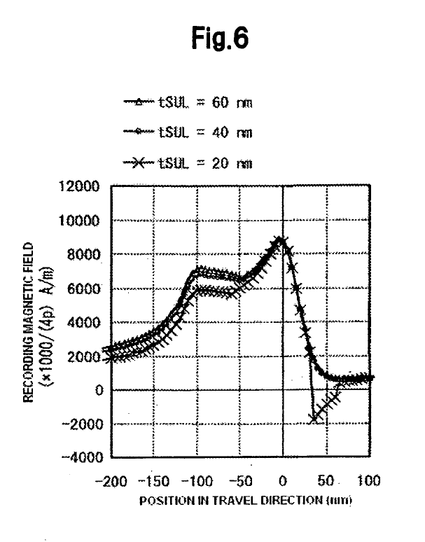

FIG. 6 shows field profiles of magnetic field in the downtrack direction at the track center of the recording head 25, which includes the trailing shield 32 and the side shields 33. It can be known therefrom that as the thickness of the soft magnetic underlayer 20 decreases, an undershoot magnetic field increases.

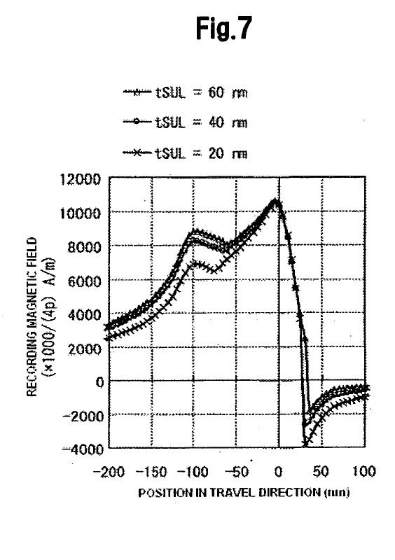

FIG. 7 shows field profiles of magnetic field in the downtrack direction at the track center of the magnetic head including only the trailing shield 32. It can be known therefrom that, similarly as FIG. 6, as the thickness of the soft magnetic underlayer 20 decreases, the reverse polarity magnetic field increases.

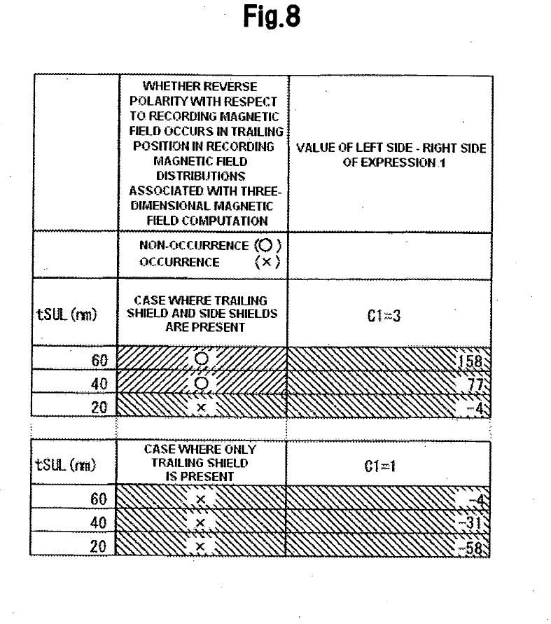

FIG. 8 shows values of the left side right side of [Expression 4] and the presence or absence of the reverse polarity magnetic field. The case of the positive value is indicative that [Expression 1] is satisfied. As seen from the diagram, the configuration of an embodiment satisfying [Expression 1] corresponds to the cases that the reverse polarity magnetic field is absent. Hence, in the case the configuration of the present embodiment is employed, the occurrence of the reverse polarity magnetic field with respect to the recording magnetic field can be inhibited. Thereby, erasure or attenuation of the already-recorded magnetized information is inhibited, and consequently, a high density magnetic recording device can be provided.

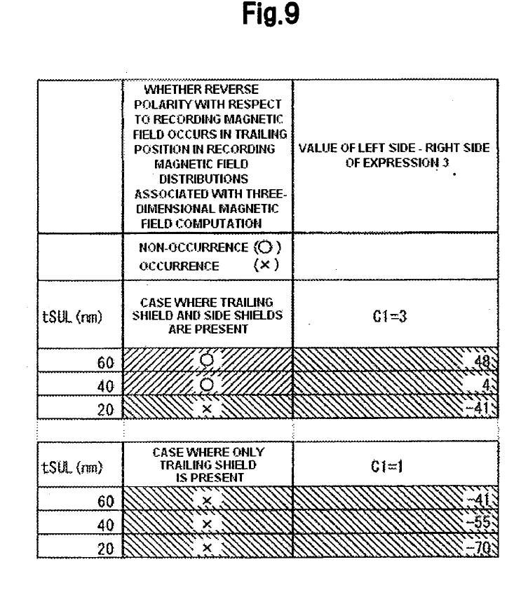

FIG. 9 shows values of the left side-right side of [Expression 3] and the presence or absence of the reverse polarity magnetic field. C is set to be 3 or 1. The case of the positive value is indicative that [Expression 3] is satisfied. As seen from the diagram, it can be known that the presence or absence matches with that of the configuration of the embodiment satisfying [Expression 3]. This is because as the film thickness of the intermediate layer 21 is smaller, the magnetic flux is more likely to flow to the soft magnetic underlayer 20, and as the magnetic distance is smaller, the magnetic flux is more likely to return to the shields through the soft magnetic underlayer 20. As described above, in the case the configuration of the present embodiment is employed, the occurrence of the reverse polarity magnetic field with respect to the recording magnetic field can be inhibited. Thereby, erasure or attenuation of the already-recorded magnetized information is inhibited, and consequently, a high density magnetic recording device can be provided.

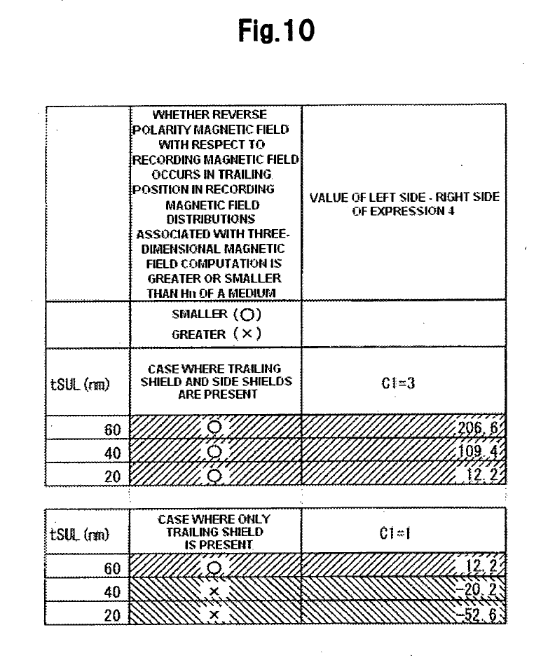

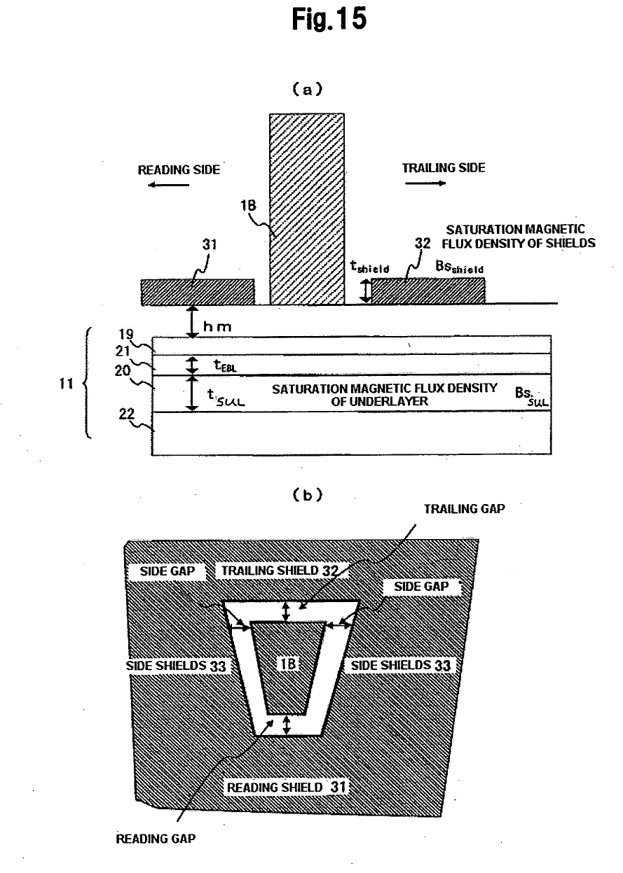

Further, while the reverse polarity magnetic field may be absent, a certain amount is considered to be tolerable depending upon the properties of the medium. FIG. 14 shows a conceptual schematic view of magnetic potential field curves of the medium. It is considered that, in the event the absolute value of the magnetic field is smaller than the absolute value of Hn of the medium, a change does not occur in magnetization, so that deterioration or erasure of recorded magnetized information can be prevented. A maximum recording magnetic field Hmax is assumed to be 10000(×1000/4π (A/m)). Hn of the perpendicular magnetic recording medium is about 2000(×1000/4π (A/m)). FIG. 10 shows values of the left side right side of [Expression 4] and whether the reverse polarity magnetic field is greater than Hn of a medium shown in FIGS. 15(a) and 15(b). C is set to be 3 or 1. The case of the positive value is indicative that [Expression 4] is satisfied. As seen from the diagram, it can be known that the reverse polarity magnetic field is smaller than Hn matches with that of the configuration of the present embodiment satisfying [Expression 4]. In the case the configuration of the present embodiment is employed, the occurrence of the reverse polarity magnetic field with respect to the recording magnetic field can be inhibited. Thereby, erasure or attenuation of the recorded magnetized information is inhibited, and consequently, a high density magnetic recording device can be provided.

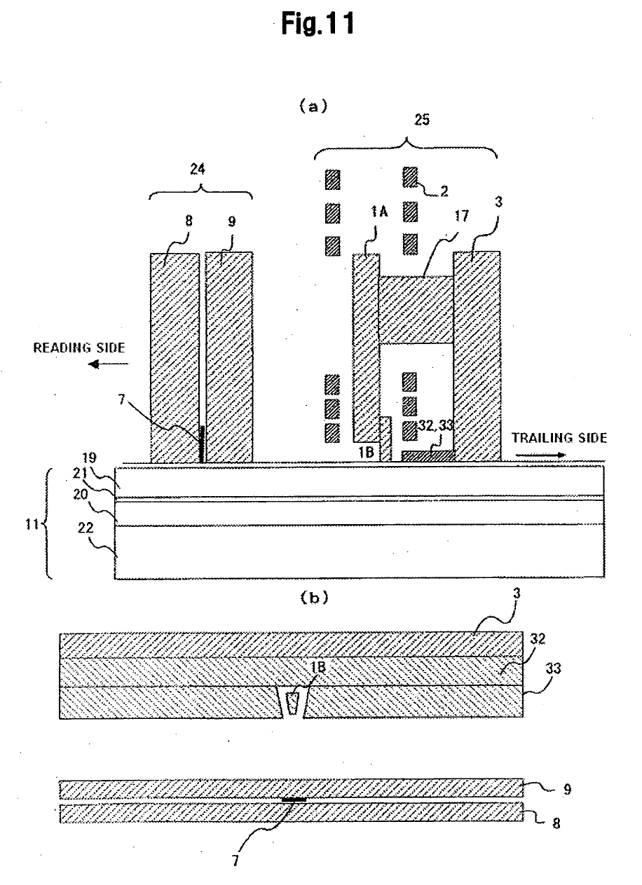

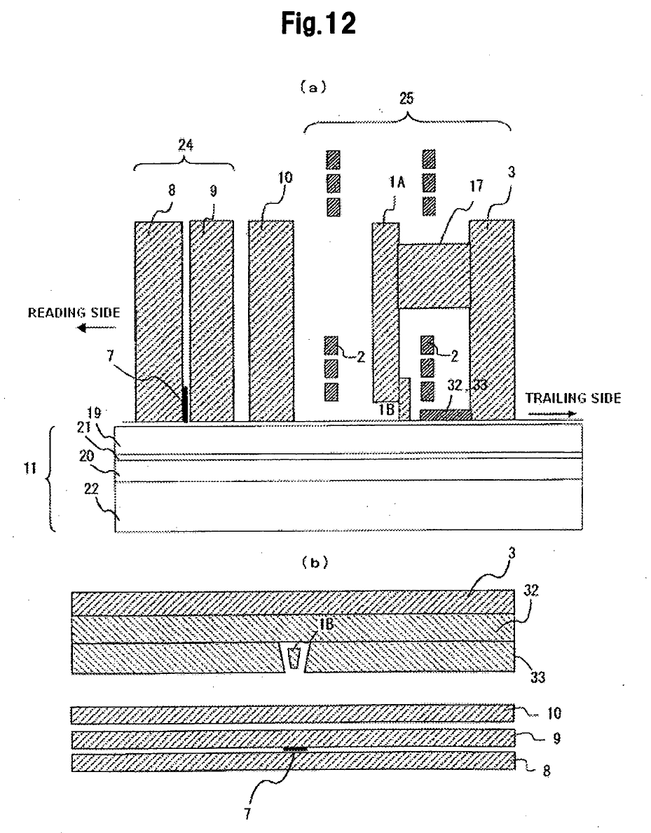

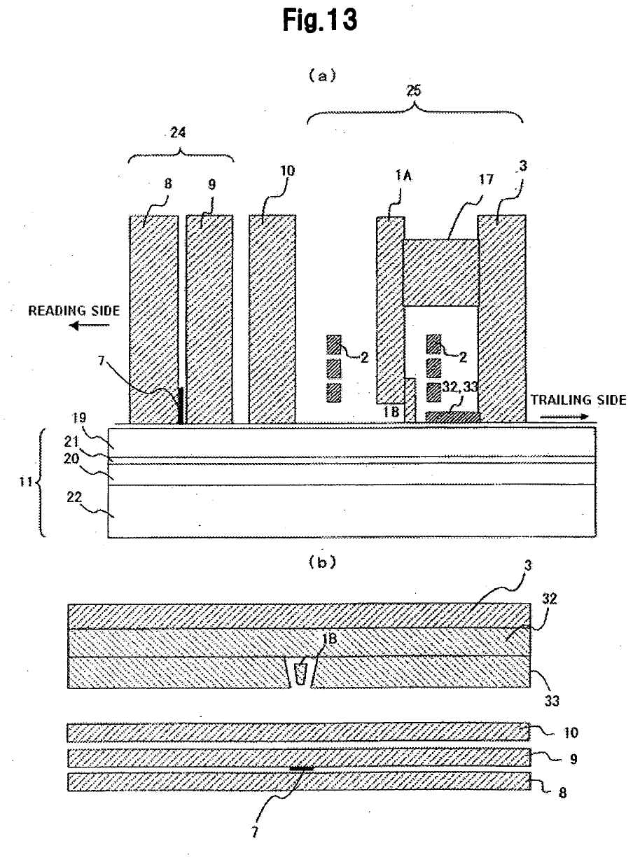

Next, modified examples of the magnetic head 14 shown in FIGS. 3(a) and 3(b) will be described hereinbelow. An example configuration shown in FIGS. 11(a) and 11(b) is such that coils 2 are disposed on both the trailing side and leading side of the main pole 1, and other configurations are identical to those of FIGS. 3(a) and 3(b). According to the present configuration, the recording magnetic field occurring in the main pole 1 can be increased. An example configuration shown in FIGS. 12(a) and 12(b) is such that an auxiliary shield 10 is disposed to reduce the magnetic field entering into the read element position. Other configurations are identical to those of FIGS. 11(a) and 11(b). Further, an example configuration shown in FIGS. 13(a) and 13(b) is such that the coil 2 is helically formed about the main magnetic pole yoke section 1A and the main magnetic pole tip 1B. Other configurations are identical to those of FIGS. 12(a) and 12(b). According to this configuration, since the coils 2 are directly formed about the main magnetic pole yoke section 1A and the main magnetic pole tip 1B, the recording magnetic field can be even more increased, and the magnetic field entering into the read element can be reduced.

Further, embodiments of the present invention can be applied even in the case a shield is disposed on the leading side, as shown in FIGS. 15(a) and 15(b). A reading shield 31 is capable of inhibiting spreading of a low magnetic field on the reading side. In particular, the reading shield 31 is capable of inhibiting the magnetic field from being applied to adjacent tracks when a skew angle takes place. In the case the reading shield 31 is disposed, C=C1=4 in [Expression 4]. In the event a skew angle is not present even with the reverse polarity magnetic field magnetic field applied to the reading side, the magnetic field is applied to an own track, so that the magnitude of influence on the already-recorded magnetized information is small. However, when a skew angle has taken place, there is a likelihood that the magnetic field is applied to adjacent tracks. However, according to the scope of embodiments of the present invention, even in such a case as described above, erasure or attenuation of the already-recorded magnetized information is inhibited, thereby making it possible to provide a high density magnetic recording device.

Similarly as in the above, embodiments of the present invention can even be applied to, for example, a discrete track medium on which depression and protrusion sections are provided along the tracking direction and a patterned medium on which depression and protrusion sections are provided also along the bit direction, the conditions for the configuration described above can be satisfied. Thereby, the strength of the magnetic field to be applied adjacent tracks can be reduced in the perpendicular magnetic recording device. Thereby, erasure or attenuation of the recorded magnetized information is inhibited, and consequently, the high density magnetic recording device can be provided. Further, in the case magnetic recording mediums or media are of the type in which depression and protrusion sections for defining recording bits are provided, the effects of embodiments of the present invention can be obtained even in thermally assisted recording.

While the present invention is described with reference to particular embodiments, the present invention is not limited to these embodiments. Those skilled in the art may easily make changes, additions, and modifications to the embodiments without departing from the invention. For example, embodiments of the present invention can be applied to magnetic disk drives other than HDDs, and can be applied to magnetic disk drives that each include a magnetic head including only a recording head.

What is claimed is:

1. A magnetic disk drive comprising:
a magnetic disk for perpendicular magnetic recording including a soft magnetic underlayer, an intermediate layer of a nonmagnetic material, and a magnetic recording layer; and
a magnetic head for perpendicular magnetic recording including a main magnetic pole, an auxiliary magnetic pole, a trailing shield that is disposed via a non-magnetic film on a trailing side of the main magnetic pole and that is in contact with the auxiliary magnetic pole on a reverse side with respect to a side opposing the main magnetic pole, and side shields disposed via a non-magnetic film on both sides of the main magnetic pole in a track width direction,
wherein, where a saturation magnetic flux density of the soft magnetic underlayer is Bs_{SUL} and a film thickness thereof is t_{SUL}; a saturation magnetic flux density of the trailing shield and side shields is Bs_{shield} and a film thickness thereof is t_{shield}; and the number of sides of the trailing shield and the side shields, which sides oppose the main magnetic pole, is C1, the following expression is satisfied:
Bs_{SUL}×t_{SUL}>(1/C1)×Bs_{shield}×t_{shield}.

2. The magnetic disk drive according to claim 1, wherein the saturation magnetic flux density of the trailing shield is Bs_{trailing}_{_{—}}_{shield} and the film thickness thereof is tₜᵣₐᵢₗᵢₙ_{_{—}}_{shield}; and
the saturation magnetic flux density of the side shields is Bs_{side}_{_{—}}_{shield} and the film thickness thereof t_{side}_{_{—}}_{shield}, the following expression is satisfied:
Bs_{SUL}×t_{SUL}>Bs_{trailing}_{_{—}}_{shield}×t_{trailing}_{_{—}}_{shield}+(½)×Bs_{side}_{_{—}}_{shield}×t_{side}_{_{—}}_{shield}.

3. The magnetic disk drive according to claim 1, wherein the saturation magnetic flux density of the trailing shield is Bs_{trailing}_{_{—}}_{shield} and the film thickness thereof is tₜᵣₐᵢₗᵢₙ_{_{—}}_{shield}; the saturation magnetic flux density of one of the side shields is Bs_{side}_{_{—}}_{shield}_{_{—}}₁ and the film thickness thereof is t_{side}_{_{—}}_{shield}_{_{—}}₁; and the saturation magnetic flux density of the other side shield is Bs_{side}_{_{—}}_{shield}_{_{—}}₂ and the film thickness thereof is t_{side}_{_{—}}_{shield}_{_{—}}₂, the following expression is satisfied:
Bs_{SUL}×t_{SUL}>Bs_{trailing}_{_{—}}_{shield}×t_{trailing}_{_{—}}_{shield}+Bs_{side}_{_{—}}_{shield}_{_{—}}₁×t_{side}_{_{—}}_{shield}_{_{—}}₁+Bs_{side}_{_{—}}_{shield}_{_{—}}₂×t_{side}_{_{—}}_{shield}_{_{—}}₂.

4. The magnetic disk drive according to claim 1, wherein the trailing shield and the side shields are provided as an integral unit.

5. The magnetic disk drive according to claim 1, wherein a magnetic distance from the magnetic head to the magnetic recording layer of the magnetic disk is hm, and a film thickness of the intermediate layer is tEBL, the following expression is satisfied:
$$\frac{{Bs}_{SUL} \times {t}_{SUL}}{tEBL} > ( \frac{1}{C 1} ) \times \frac{{Bs}_{shield } \times {t}_{shield}}{hm} .$$

6. The magnetic disk drive according to claim 1, wherein a rate between a maximum recording magnetic field strength of the magnetic head and a value of a magnetic field with which a tangent line drawn from a negative coercive force of the magnetic disk becomes saturation magnetization is C3, the following expression is satisfied:
$${Bs}_{SUL} \times {t}_{SUL} > ( 1 + C 3 ) \times ( \frac{1}{C 1} ) \times {Bs}_{shield } \times {t}_{shield} .$$

7. The magnetic disk drive according to claim 1, further comprising a reading shield disposed on a reading side of the main magnetic pole via the non-magnetic film.

8. A magnetic disk drive comprising:
a magnetic disk for perpendicular magnetic recording including a magnetic recording layer and a soft magnetic underlayer; and
a magnetic head for perpendicular magnetic recording including a main magnetic pole, an auxiliary magnetic pole, a trailing shield that is disposed via a non-magnetic film on a trailing side of the main magnetic pole and that is in contact with the auxiliary magnetic pole on a reverse side with respect to a side opposing the main magnetic pole, and side shields disposed via a non-magnetic film on both sides of the main magnetic pole in a track width direction,
wherein, where a saturation magnetic flux density of the soft magnetic underlayer is Bs_{SUL} and a film thickness thereof is t_{SUL}; a saturation magnetic flux density of the trailing shield and side shields is Bs_{shield} and a film thickness thereof is t_{shield}; and a rate that the trailing shield and the side shields oppose an outer circumference of the main magnetic pole is C2, the following expression is satisfied:
Bs_{SUL}×t_{SUL}>(C2)×Bs_{shield}×t_{shield}.

9. The magnetic disk drive according to claim 8, wherein the trailing shield and the side shields are provided as an integral unit.

10. The magnetic disk drive according to claim 8, wherein a magnetic distance from the magnetic head to the magnetic recording layer of the magnetic disk is hm, and a film thickness of the intermediate layer is tEBL, the following expression is satisfied:
$$\frac{{Bs}_{SUL} \times {t}_{SUL}}{tEBL} > ( C 2 ) \times \frac{{Bs}_{shield } \times {t}_{shield}}{hm} .$$

11. The magnetic disk drive according to claim 8, wherein a rate between a maximum recording magnetic field strength of the magnetic head and a value of a magnetic field with which a tangent line drawn from a negative coercive force of the magnetic disk becomes saturation magnetization is C3, the following expression is satisfied:
Bs_{SUL}×t_{SUL}>(1+C3)×(C2)×Bs_{shield}×t_{shield}.
